(19) United States
(12) Patent Application Publication
(10) Pub. No.: US 2004/0132456 A1
(43) Pub. Date: Jul. 8, 2004

(54) Wireless system, wireless base station and wireless terminal

(75) Inventors: Daisuke Takeda, Tokyo (JP); Manabu Mukai, Kanagawa-Ken (JP)

Correspondence Address: OBLON, SPIVAK, MCCLELLAND, MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 10/673,153

(22) Filed: Sep. 30, 2003

(30) Foreign Application Priority Data
Sep. 30, 2002 (JP) 2002-285862

(51) Int. Cl. H04H 1/00; H04Q 7/20

(52) U.S. Cl. 455/450; 455/3.05

(57) ABSTRACT

A wireless system according to the present invention, comprising: a wireless apparatus which performs a broadcast service for a plurality of wireless terminals; simplex first wireless channels each being set between the wireless terminal and the plurality of wireless terminals, in which the wireless apparatus performs the broadcast service to the plurality of wireless terminals; and a bidirectional second wireless channel set between the wireless apparatus and at least portion of the plurality of wireless terminals, which offers an supplemental service relating to the broadcast service.

### CROSS REFERECCE TO RELATED APPLICATIONS

This application claims benefit of priority under 35USC § 119 to Japanese Patent Application No. 2002-285862, filed on Sep. 30, 2002, the entire contents of which are incorporated by reference herein.

### BACKGROUND OF THE INVENTION

1. Field of the Invention

The present invention relates to a wireless system, a wireless base station and a wireless terminal, which provide a broadcast service.

2. Related Art

Currently, satellite broadcasting and ground-based broadcasting are popular as the broadcast service. It is anticipated that an Internet connection service using a wireless local area network (LAN) and the broadcast service using digitalized terrestrial television will spread in the future. Also in the recent cellular system, similar broadcasting service is available on a downlink shared channel in 3G cellular system (see Japanese Patent Publication No. 2002-118553).

In the above-mentioned broadcast service, the fee is charged with respect to the selected channel (service). It is natural that a user who receives many channels (services) pays the fee corresponding thereto.

In such a service, however, the quality of service (QoS) of the received channel varies depending on the radio environment.

In recent years, the digital recording medium tends to have a larger capacity, and a demand for QoS is increasing in order to record data. For example, it is expected that a demand for recording highlight scenes in music or sports programs with high quality in a digital television service.

Generally in the wireless communication, retransmission is carried out for improving the QoS. However, in the conventional wireless communication system, since repeated packet must be charged, users in a bad radio environment must pay a large amount of fee.

There is also a service in which high QoS is not always necessary depending on the information contents. The conventional system cannot meet the needs of the user who neither need high QoS nor want to pay a large amount of fee.

Moreover, in the conventional system, since each radio channel provides independent information, it cannot provide a new service by adding supplemental information to the broadcast service.

As described above, the QoS is not guaranteed with respect to the broadcast channels, and in order to guarantee the QoS in the cellular communication and so on, an automatic repeat request (ARQ) is issued to maintain the quality, even when the radio wave environment is bad. Therefore, the repeat request increases, thereby causing an increase in the charge and the traffic in the channel.

### SUMMARY OF THE INVENTION

In view of the above situation, it is an object of the present invention to provide a wireless system, a wireless base station and a wireless terminal, which can improve the quality of the broadcast service and perform appropriate accounting control. Another object of the present invention is to provide a wireless system, a wireless base station and a wireless terminal, which can perform appropriate charge collection.

A wireless system according to an embodiment of the present invention, comprising:a wireless apparatus which performs a broadcast service for a plurality of wireless terminals;

simplex first wireless channels each being set between said wireless terminal and said plurality of wireless terminals for the broadcasting service; and

a bidirectional second wireless channel being set between said wireless apparatus and said plurality of wireless terminals, for adding supplemental service to said broadcast service.

### BRIEF DESCRIPTION OF THE DRAWINGS

A more complete understanding of the present invention may be obtained by reference to the following Description of the preferred embodiments when taken in conjunction with the accompanying Drawings wherein:

FIG. 1 is a diagram showing the schematic configuration of a wireless system according to a first embodiment of the present invention.

FIG. 2 is a block diagram showing one example of the internal configuration of the wireless terminals in FIG. 1.

FIG. 3 is a block diagram showing one example of the internal configuration of the wireless terminal in FIG. 1.

FIG. 4 is a block diagram showing one example of the internal configuration of the wireless base station 2.

FIG. 5 shows a schematic configuration of the wireless system according to the second embodiment of the present invention.

FIG. 6 is a block diagram showing one example of the internal configuration of the wireless terminals 1a and 1b in FIG. 5.

FIG. 7 shows the schematic configuration of the wireless system in the third embodiment of the present invention.

FIG. 8 is a block diagram showing one example of the internal configuration of the wireless base station.

FIG. 9 is a block diagram showing one example of the internal configuration of the broadcasting station.

FIG. 10 shows the schematic configuration of the wireless system in the fourth embodiment of the present invention.

FIG. 11 is a block diagram showing one example of the internal configuration of the wireless terminals in FIG. 10.

FIG. 12 is a block diagram showing one example of the internal configuration of the wireless base station in FIG. 10.

FIG. 13 is a block diagram showing an example in which the wireless base station 2 in FIG. 10 conducts control for charge collection.

### DESCRIPTION OF THE PREFERRED EMBODIMENTS

The wireless system, the wireless base station and the wireless terminal according to the present invention will be described, with reference to the drawings.

(First Embodiment)

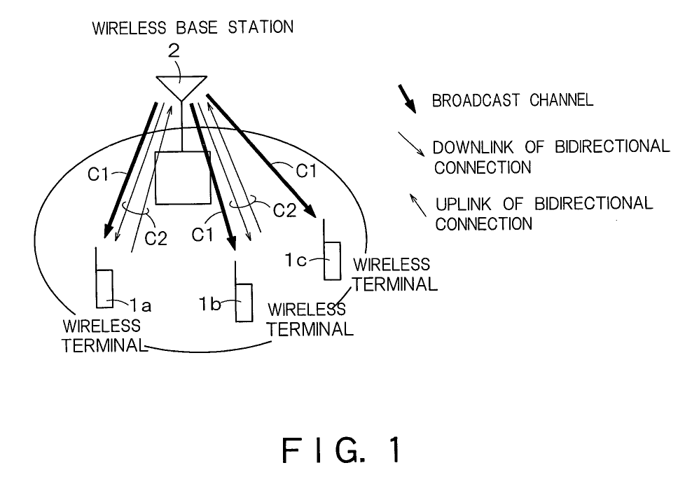

FIG. 1 is a diagram showing the schematic configuration of a wireless system according to a first embodiment of the present invention. The wireless system in FIG. 1 comprises a plurality of wireless terminals 1a, 1b and 1c, and a wireless base station 2. The wireless base station 2 has channels for the broadcast service such as a cellular method, a wireless LAN method or digital television (hereinafter, referred to as broadcast channel C1), and provides broadcast service to its coverage through the channel. The plurality of wireless terminals 1a, 1b and 1c located in this area can receive the broadcast service from the wireless base station 2.

A two-way channel C2 for providing supplemental service relating to the broadcast service is set up between the wireless base station 2 and the wireless terminals 1a and 1b, being a part of the plurality of wireless terminals. The wireless terminals 1a and 1b being a part or the wireless terminals can receive services on the broadcast channel C1 and the two-way channel C2 simultaneously. On the other hand, since the two-way channel C2 is not set up for the wireless terminal 1c, the wireless terminal 1c can only receive the broadcast service.

The supplemental service herein includes; for example, data retransmission request with respect to error compensation, and relevant information of broadcast data (more specifically, detailed data, web link information, and relevant data corresponding to the data type: for example, if the broadcast data is an image, an image from another angle, and supplemental information for obtaining another sound and refining the image).

The two-way channel C2 is provided for guaranteeing the QoS of the broadcast service. The individual wireless terminals 1a, 1b and 1c may require different QoS (required QoS), and for example, the required QoS thereof is BER=10⁻⁴, and the required QoS of the wireless terminal 1c is BER=10⁻⁶.

In order to meet the required QoS, the two-way channel C2 issues Automatic Repeat Request (ARQ) to the wireless base station 2. When issuing the ARQ, the wireless terminals 1a and 1b notify whether there is an error in the received packet to the wireless base station 2, by using the uplink of the two-way channel C2. The wireless base station 2 retransmits a part of the packets transmitted on the broadcast channel C1 by using the downlink of the two-way channel C2, in response to the ARQ from the wireless terminals 1a and 1b. Therefore, the wireless terminals 1a and 1b can guarantee the QoS with respect to the broadcast channel C1.

On the other hand, the wireless terminal 1c, for which the two-way channel C2 is not set up, can receive the broadcast service, but cannot issue the ARQ, and hence the QoS is not guaranteed. However, the communication traffic can be reduced by the portion in which the two-way channel C2 is not set up.

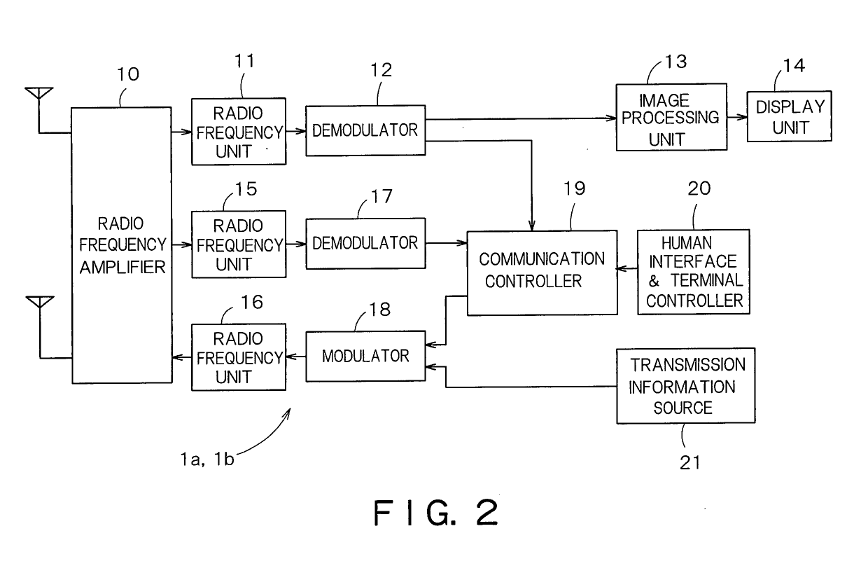

FIG. 2 is a block diagram showing one example of the internal configuration of the wireless terminals 1a and 1b in FIG. 1. The wireless terminals 1a and 1b in FIG. 2 comprise a radio frequency amplifier 10, a radio frequency unit 11 corresponding to the broadcast channel C1, a demodulator 12, an image processing unit 13, a display unit 14, wireless units 15 and 16 corresponding to the two-way channel C2, a demodulator 17, a modulator 18, a communication controller 19, an human interface & terminal controller 20 and a transmission information source 21, respectively.

The wireless unit 11 receives a packet transmitted via the broadcast channel C1 from the wireless base station 2. This packet is demodulated by the demodulator 12, and then subjected to image processing in the image processing unit 13, and is displayed on the display unit 14.

The wireless unit 15 receives a packet transmitted via the two-way channel C2 from the wireless base station 2. This packet is demodulated by the demodulator 17, and then transmitted to the communication controller 19. The communication controller operates in accordance with protocol software therein for communication between the terminal and base station.

The packet transmitted from the transmission information source 21 is modulated by the modulator 18, and then transmitted from the wireless unit 16 to the two-way channel C2.

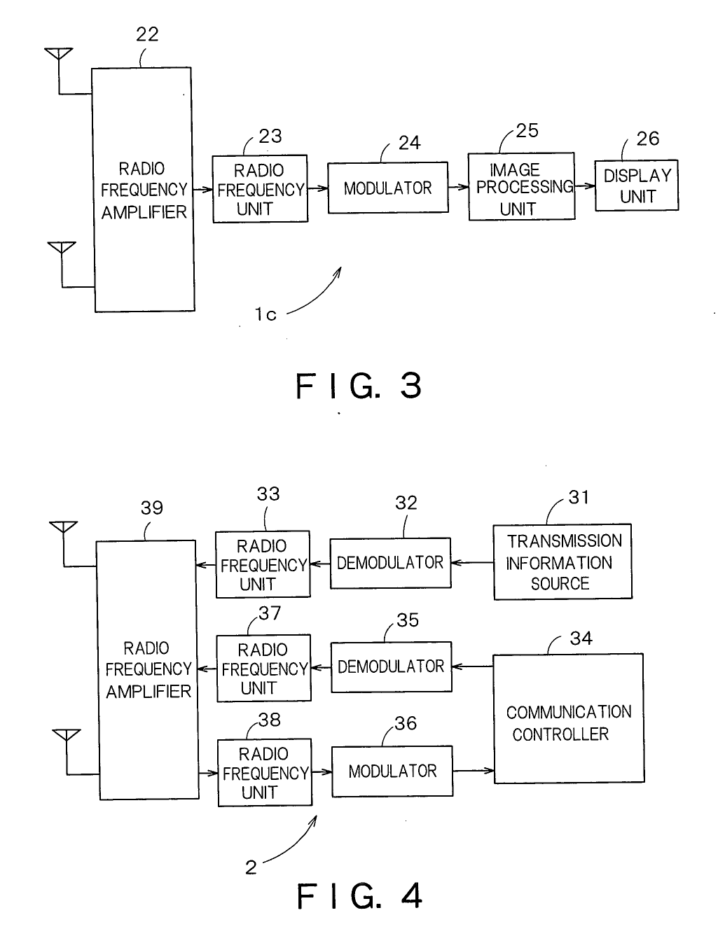

FIG. 3 is a block diagram showing one example of the internal configuration of the wireless terminal 1c in FIG. 1. As shown in the figure, the wireless terminal 1c has only the broadcast channel C1, and hence comprises only a radio frequency amplifier 22, a wireless unit 23, a demodulator 24, an image processing unit 25 and a display unit 26. Further, the internal configuration of the wireless terminal 1c may be such that the wireless terminal 1c has the same configuration as those of the wireless terminals 1a and 1b, but does not use the part corresponding to the two-way channel C2.

FIG. 4 is a block diagram showing one example of the internal configuration of the wireless base station 2. The wireless base station 2 in FIG. 4 comprises a transmission information source 31, a modulator 32 and a wireless unit 33 corresponding to the broadcast channel C1, and a communication controller 34, a modulator 35, a demodulator 36, and wireless units 37 and 38 corresponding to the two-way channel C2, and a radio frequency amplifier 39.

A packet transmitted from the transmission information source 31 is modulated by the modulator 32, and transmitted to the two-way channel C2 via the wireless unit 33. A packet from the communication controller 34 is modulated by the modulator 35, and transmitted to the two-way channel C2 via the wireless unit 37. A packet transmitted from the wireless terminal 1a, 1b or 1c to the two-way channel C2 is received by the wireless unit 38, and then demodulated by the demodulator 36.

In the first embodiment, as described above, since the two-way channel C2 is set up for at least the wireless terminals 1a and 1b among the plurality of wireless terminals 1a, 1b and 1c for which the broadcast channel C1 is set up, when the QoS of the broadcast channel C1 is bad, ARQ can be issued on the two-way channel C2, to receive the repeat packet, thereby providing guarantee for the QoS suitable for the respective wireless terminals 1. Further, since only the broadcast channel C1 is set up with respect to the wireless terminal 1c, which does not require high QoS, the communication traffic can be reduced.

(Second Embodiment)

In a second embodiment, the information transmitted on the broadcast channel C1 can be synchronized with the information transferred on the two-way channel C2.

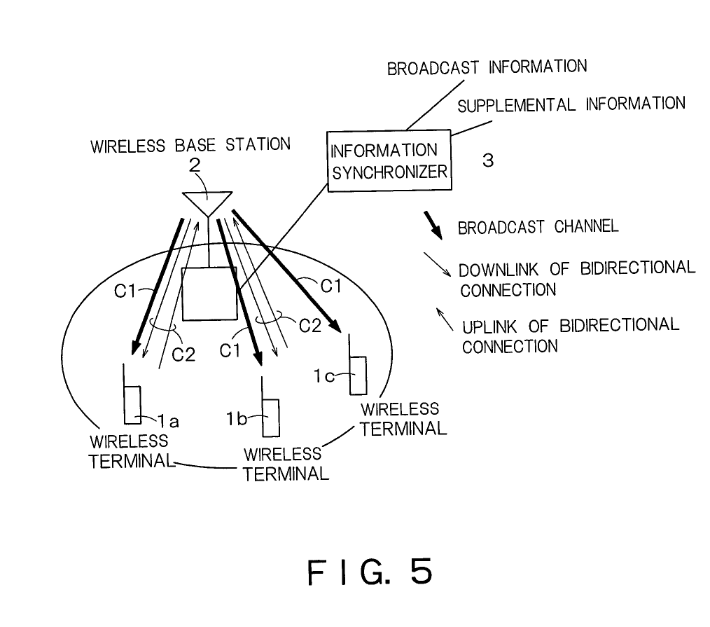

FIG. 5 shows a schematic configuration of the wireless system according to the second embodiment of the present invention. In FIG. 5, the like constituents with those in FIG. 1 are denoted by the like reference numerals, and only the different points from the first embodiment shown in FIG. 1 will be described below.

The wireless system in FIG. 5 comprises an information synchronizing section 3, which synchronizes the broadcast channel C1 and the two-way channel C2 with each other. This information synchronizing section 3 may be provided inside of the wireless base station 2, or may be provided separately from the wireless base station 2.

Supplemental information with respect to the information on the broadcast channel C1 can be synchronized and transmitted on the two-way channel C2, by means of the action of the information synchronizing section 3. The supplemental information in this case includes, for example, a scramble key for the broadcast information, acknowledgement (ACK) or NCK of ARQ, repeat packet, redundant bits with respect to channel coding used in the broadcast channel C1, and a link associated with the broadcast information.

The wireless terminal 1, for which the two-way channel C2 is set up, receives the information on the two-way channel C2 transmitted synchronously with the information on the broadcast channel C1, to make it easy to associate the information with each other. As a result, the QoS can be improved, and coded data can be decoded in real time.

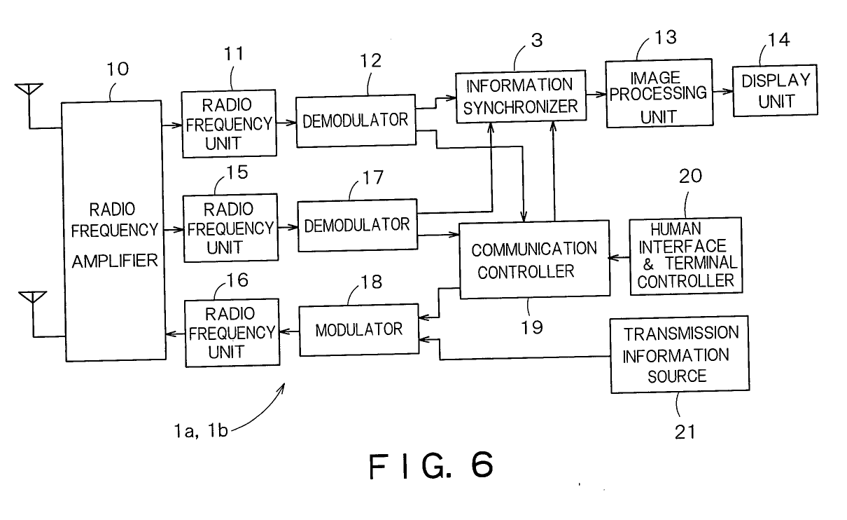

FIG. 6 is a block diagram showing one example of the internal configuration of the wireless terminals 1a and 1b in FIG. 5. The wireless terminals 1a and 1b in FIG. 6 comprises the information synchronizing section 3 in addition to the configuration in FIG. 2. As described above, the information synchronizing section 3 may not necessarily be in the wireless terminal, but in FIG. 6, an example in which the information synchronizing section 3 is provided in the wireless terminals 1a and 1b is shown.

The information synchronizing section 3 synchronizes signals demodulated by the demodulator 12 with each other. As a result, information transferred on the broadcast channel C1 and the two-way channel C2 can be associated with each other easily.

The wireless terminal 1c in FIG. 5 is constructed in the same manner as shown in FIG. 3, and the wireless base station 2 is constructed in the same manner as shown in FIG. 4, and hence the explanation thereof is omitted. The wireless terminal 1c may have the same configuration as that shown in FIG. 6.

In the second embodiment, since the information transferred on the broadcast channel C1 and the two-way channel C2 is synchronized by the information synchronizing section 3, the QoS can be improved, and coded data can be decoded in real time.

(Third Embodiment)

In a third embodiment, a broadcasting station is provided separately from the wireless base station.

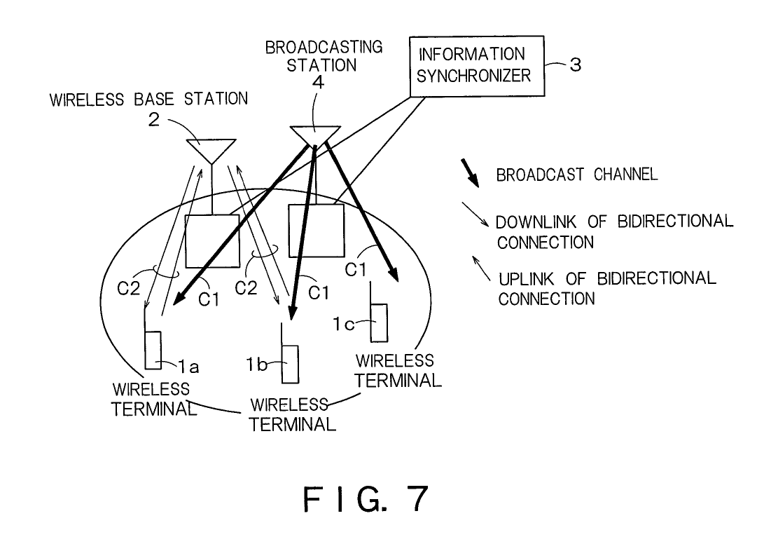

FIG. 7 shows the schematic configuration of the wireless system in the third embodiment of the present invention. The wireless system in FIG. 7 comprises a wireless base station 2 having a two-way channel C2 such as cellular, PHS (Personal Handy Phone System) and wireless LAN, a broadcasting station 4 which provides a broadcast service such as digital television and wireless LAN, and an information synchronizing section 3 which synchronizes the wireless base station 2 and the broadcasting station 4 with each other.

The broadcasting station 4 provides the broadcast service to its coverage, by using the broadcast channel C1. A plurality of wireless terminals 1a, 1b and 1c capable of receiving the broadcast service exist in this coverage. Wireless terminals 1a and 1b among these wireless terminals 1a, 1b and 1c, can communicate with the wireless base station 2 through the two-way channel C2. The remaining wireless terminal 1c can receive only the broadcast service.

The information synchronizing section 3 synchronizes the information on the broadcast channel C1 and the information on the two-way channel C2 with each other. As a result, supplemental information with respect to the information on the broadcast channel C1 can be synchronized and transmitted on the two-way channel C2, as in the second embodiment.

The wireless terminals 1a and 1b in FIG. 7 are constructed in the same manner as shown in FIG. 6, and the wireless terminal 1c is constructed in the same manner as shown in FIG. 3.

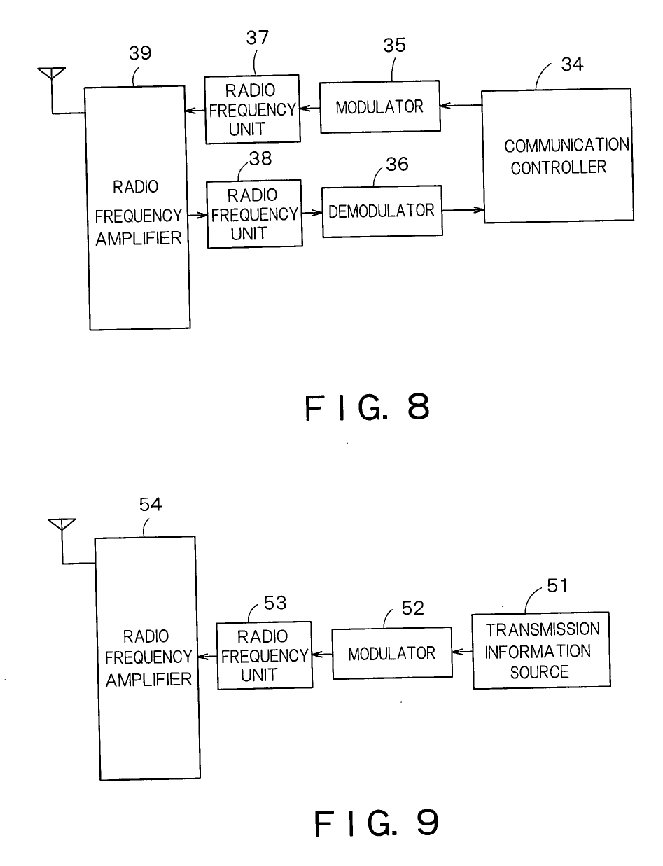

FIG. 8 is a block diagram showing one example of the internal configuration of the wireless base station. The wireless base station in FIG. 8 comprises a wireless unit corresponding to the two-way channel C2, a modulator, a demodulator and a communication controller 34, but does not have constituents corresponding to the broadcast channel C1.

FIG. 9 is a block diagram showing one example of the internal configuration of the broadcasting station. The broadcasting station in FIG. 9 comprises a transmission information source 51, a modulator 52, a wireless unit 53 and a radio frequency amplifier 54.

By having the configuration as shown in FIG. 7, the QoS can be guaranteed and the security can be improved, with respect to the information on the broadcast channel C1, and an supplemental function can be added. Accordingly, convenience of users of the wireless terminal 1, who receive the broadcast service, can be improved.

As a modified example of the third embodiment, a wireless system having a buffer function can be considered, wherein the same information on the broadcast channel C1 delayed by a certain period of time is transmitted on the two-way channel C2. As a result, the QoS can be improved by means of the time diversity effect with respect to the broadcast information, and replay information can be distributed, thereby enabling further improvement in the convenience of users.

(Fourth Embodiment)

In a fourth embodiment, key information for decoding scramble information transmitted on the broadcast channel C1 is transmitted on the two-way channel C2.

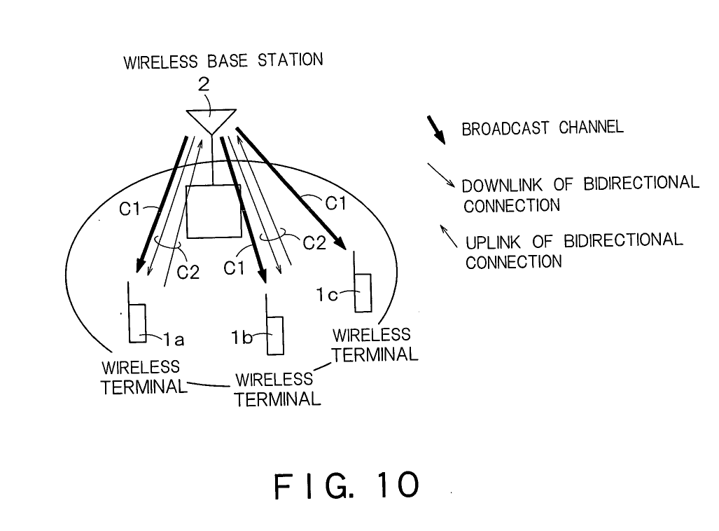

FIG. 10 shows the schematic configuration of the wireless system in the fourth embodiment of the present invention. The wireless system in FIG. 10 comprises a wireless base station 2 having the broadcast channel C1, and a plurality of wireless terminals 1a, 1b and 1c capable of receiving the two-way channel C1, as in FIG. 1. A part of the plurality of wireless terminals 1a, 1b and 1c can communicate with the wireless base station 2 through the two-way channel C2, and for the remaining wireless terminal 1, only the broadcast channel C1 is set up. The QoS is guaranteed for the wireless terminal 1, for which the two-way channel C2 is set up, but is not guaranteed for other wireless terminals 1.

Different from the first embodiment, the broadcast channel C1 is scrambled in a peculiar manner to the coverage (or in a peculiar manner to the wireless system). Therefore, the information cannot be decoded only by receiving the information on the broadcast channel C1.

Only the wireless terminal 1 having registered for the broadcast service can receive the key information for decoding the scrambled information on the broadcast channel C1, through the two-way channel C2.

As in the first embodiment, the two-way channel C2 is also used for the ARQ and packet retransmission, when the QoS on the broadcast channel C1 is bad.

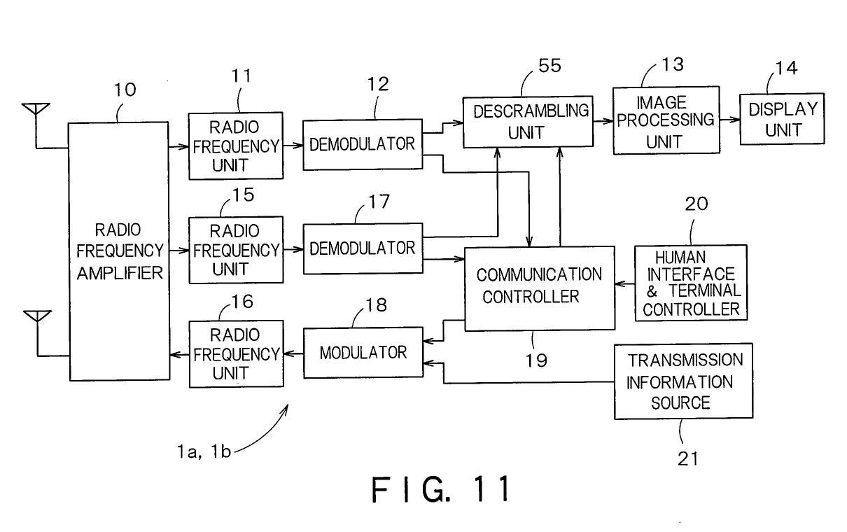

FIG. 11 is a block diagram showing one example of the internal configuration of the wireless terminals 1a and 1b in FIG. 10. The wireless terminals 1a and 1b in FIG. 11 comprises a descrambling unit 55 for decoding the information transmitted on the broadcast channel C1, in addition to the configuration shown in FIG. 2. The descrambling unit 55 receives the key information transmitted via the two-way channel C2 from the communication controller 19.

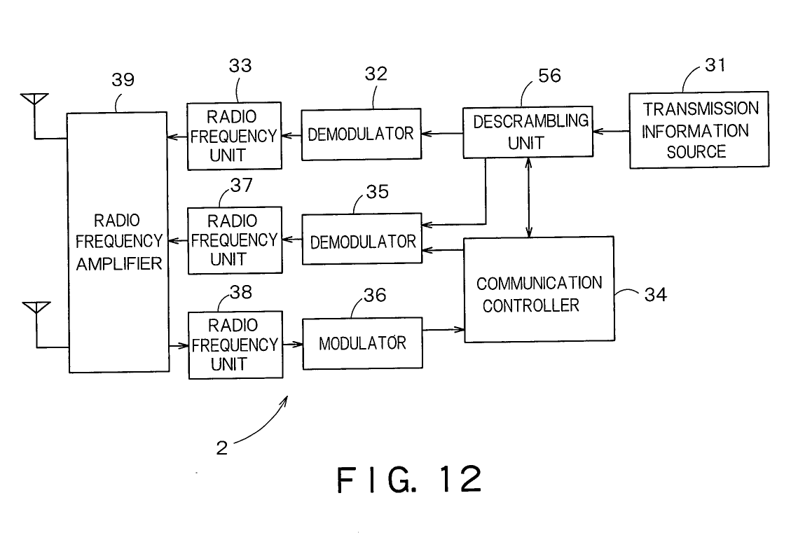

FIG. 12 is a block diagram showing one example of the internal configuration of the wireless base station in FIG. 10. The wireless base station in FIG. 12 has a scrambling section 56 for encoding the transmission packet, in addition to the configuration in FIG. 4. The scrambling section 56 encodes the transmission packet from the transmission information source 21, using a scramble key. The encoded packet is transmitted to a modulator, and the scramble key is transmitted to the communication controller 19.

In the fourth embodiment, since the key information for decoding the scrambled information on the broadcast channel C1 is transmitted only to the wireless terminal 1 having registered in advance via the two-way channel C2, leakage of information can be reliably prevented. Moreover, the accounting control can be evenly and accurately performed, by charging depending on the packet quantity transmitted on the two-way channel C2.

(Fifth Embodiment)

In a fifth embodiment, charging depending on the packet quantity retransmitted on the two-way channel C2 is conducted.

In the wireless system in FIG. 1, when the required QoS of the plurality of wireless terminal 1a, 1b and 1c having the two-way channel C2 is different, the packet quantity retransmitted via the two-way channel C2 should be different according to the wireless terminals 1. Normally, the retransmitted packet quantity increases, as the required QoS is high.

Therefore, accounting may be conducted according to the packet quantity retransmitted on the two-way channel C2. As a result, the higher the required QoS is, the more the fee is charged. In this manner, broadcast service is provided at free with respect to a user of the wireless terminal 1, who does not require high QoS, as in the case of radio and TV, and accounting can be conducted depending on the degree of QoS which each user requires, with respect to users of the wireless terminal 1, who require desired QoS.

Therefore, the service can be provided depending on the degree required by an individual user of the wireless terminal 1, thereby improving the convenience. Moreover, the number of users of the wireless terminal 1 who requires unnecessarily high QoS decreases, thereby providing secondary effect that the communication traffic can be decreased.

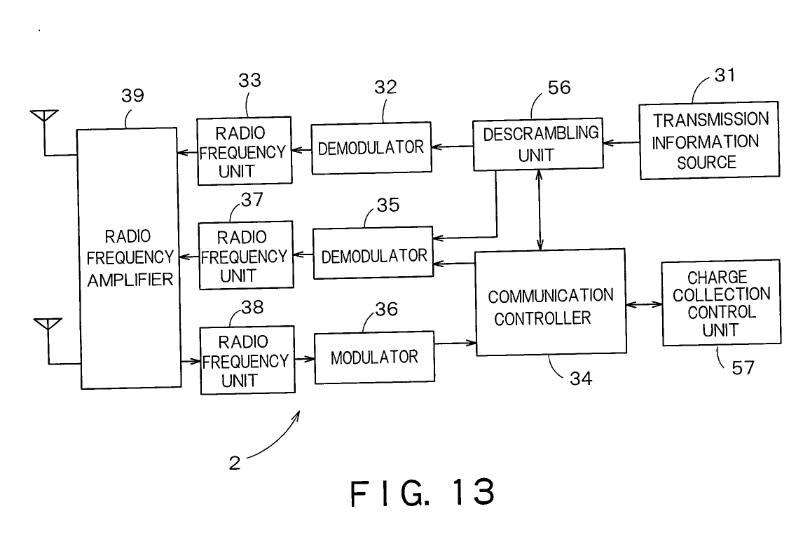

Such an accounting system is also applicable to the wireless systems shown in FIGS. 5 to 10. For example, FIG. 13 is a block diagram showing an example in which the wireless base station 2 in FIG. 10 conducts control for charge collection.

The wireless base station in FIG. 13 has charge collection unit 57 in addition to the configuration in FIG. 12. The charge collection unit 57 conducts charge collection according to the packet quantity retransmitted on the two-way channel C2.

The control for charge collection may be conducted by the wireless base station 2. In such case the charge collection units conducts the procedure for the authentication of the terminal If the terminal is authorized by this unit 57, charge collection unit 57 send the information of the terminal so as to charge the terminal by the wireless base station 2. The accounting unit 57 may be provided, separately from the wireless base station 2.

What is claimed is:

1. A wireless system, comprising:a wireless apparatus which performs a broadcast service for a plurality of wireless terminals;
simplex first wireless channels each being set between said wireless terminal and said plurality of wireless terminals for the broadcasting service; and
a bidirectional second wireless channel being set between said wireless apparatus and said plurality of wireless terminals, for adding supplemental service to said broadcast service.

2. The wireless system according to claim 1, further comprising an information synthesizer which synchronizes a time frame of information transmitted via said first and second wireless channels with each other.

3. The wireless system according to claim 1, wherein said first wireless channels transmit by encoding information; and
said second wireless channel transmits key information which encrypts information transmitted via said first wireless channel.

4. The wireless system according to claim 1, wherein an uplink of said second wireless channel transmits retransmission request information of at least portion of information transmitted via said first wireless channel; and
a downlink of said second wireless channel transmits information corresponding to said retransmission request information.

5. The wireless system according to claim 4, further comprising a charge collection control unit which charges in accordance with the amount of information transmitted via the downlink of said second wireless channel.

6. The wireless system according to claim 1, wherein said supplemental service includes at least one of data retransmission request for error compensation, offering of information relating to said broadcast service, and decrypting information of said encrypted broadcast service.

7. A wireless system, comprising:
a first wireless apparatus which performs a broadcast service for a plurality of wireless terminals;
a second wireless apparatus which performs an supplemental service relating to said broadcast service;
simplex first wireless channels each being set between said first wireless apparatus and said plurality of wireless terminals, in which said first wireless apparatus performs said broadcast service to said plurality of wireless terminals;
a bidirectional second wireless channel set between said second wireless apparatus and at least portion of said plurality of wireless terminals, which offers said supplemental service; and
an information synthesizer which synthesizes operations of said first and second wireless apparatuses with each other.

8. The wireless system according to claim 7, wherein said first wireless channel transmits information encrypted; and
said second wireless channel transmits key information which decrypts information transmitted via said first wireless channel.

9. The wireless system according to claim 7, wherein an uplink of said second wireless channels transmits retransmission request information of at least portion of information transmitted via said first wireless channel; and
a downlink of said second wireless channel transmits information corresponding to said retransmission request information.

10. The wireless system according to claim 9, further comprising a charge collection control unit which charges in accordance with the amount of information transmitted via the downlink of said second wireless channel.

11. The wireless system according to claim 7, wherein said supplemental service includes at least one of data retransmission request for error compensation, offering of information relating to said broadcast service and decryption information of said broadcast service encrypted.

12. A wireless base station, comprising:
simplex first wireless channels each being set for a plurality of wireless terminals, which performbroadcast service; and
a bidirectional second wireless channel set for at least one of said plurality of wireless terminals, which offers an supplemental service relating to said broadcast service.

13. The wireless base station according to claim 12, wherein said first wireless channel transmits information encrypted; and
said second wireless channel transmits key information which decrypts information transmitted via said first wireless channel.

14. The wireless base station according to claim 12, wherein an uplink of said second wireless channel transmits retransmission request information relating to at least portion of information transmitted via said first wireless channel; and
a downlink of said second wireless channel transmits information corresponding to said retransmission request information.

15. The wireless base station according to claim 14, further comprising a charge collection control unit which charges in accordance with the amount of information transmitted via the downlink of said second wireless channel.

16. A wireless terminal which receives offering of a broadcast service from a wireless apparatus, comprising:
a simplex first wireless channel set for said wireless apparatus, which receives a broadcast service from said wireless apparatus; and
a bidirectional second wireless channel set for said wireless apparatus, which receives an supplemental service relating to said broadcast service from said wireless apparatus.

17. The wireless terminal according to claim 16, wherein said first wireless channel transmits information encrypted; and
said second wireless channel transmits key information which encrypts information transmitted via said first wireless channel.

18. A wireless terminal, comprising:
a simplex first wireless channel set for a first wireless apparatus, which receives a broadcast service from said first wireless apparatus; and
a bidirectional second wireless channel set for a second wireless apparatus, which receives an supplemental service relating to said bidirectional service from said second wireless apparatus.

19. The wireless terminal according to claim 18, wherein said first wireless channel transmits information encrypted; and
said second wireless channel transmits key information which decrypts information transmitted via said first wireless channel.

20. A wireless communication method, comprising:
performing a broadcast service from a wireless apparatus to a plurality of wireless terminals, by using simplex first wireless channels each being set between said wireless apparatus which performs the broadcast service for said plurality of wireless terminals and each of said plurality of wireless terminals; and
offering an supplemental service relating to said broadcast service by using a bidirectional wireless channel set between said wireless apparatus and at least one of said plurality of wireless terminals.
